(19) United States
(12) Patent Application Publication
(10) Pub. No.: US 2010/0038834 A1
(43) Pub. Date: Feb. 18, 2010

(54) Structurally Optimized Hydro-Elastic Joint and Method of Making It

(75) Inventors: Christophe Criaud, Riom (FR); Franck Honneur, Clermont-Ferrand (FR); Philippe Souyri, Saint-Genes-Du-Retz (FR)

Correspondence Address: COHEN, PONTANI, LIEBERMAN & PAVANE LLP, 551 FIFTH AVENUE, SUITE 1210, NEW YORK, NY, 10176, US

(73) Assignee: MICHELIN RECHERCHE ET TECHNIQUE S.A., Granges-Paccot (CH)

(21) Appl. No.: 12/297,095

(22) PCT Filed: Apr. 4, 2007
(86) PCT No.: PCT/FR2007/000576

§ 371 Date: Oct. 6, 2009

(30) Foreign Application Priority Data
Apr. 14, 2006 (FR) 06/03364
Dec. 1, 2006 (FR) 06/10543

(51) Int. Cl. F16C 27/06; B29C 45/14

(52) U.S. Cl. 267/140.13; 264/261

(57) ABSTRACT

A hydroelastic joint having first and second axial ends (B, H) spaced apart from one another along a longitudinal axis (Y) and including, at an increasing radial distance from this axis, at least one internal frame (1), an intermediate frame (2) with a window or “cage”, and an external sleeve (4), which joint also includes an elastomer packing (5) molded with at least one molding insert chosen from the assembly including the internal frame (1), the cage (2) and the external sleeve (4), in which said packing (5) at least partially forms a wall for at least two hydraulic fluid chambers (6) communicating with one another through at least one channel (30), and sealing means (3). The assembly formed by the packing (5) and each insert has at least an essentially axial molding reserve. Each chamber (6) and each channel (30) are defined inside the molding reserve and are sealed or delimited, at least in an axial direction, by the sealing means (3).

The invention relates in general to vibration control techniques, and in particular a hydroelastic joint designed to assemble two parts of a stress transmission structure, in particular a motor vehicle, and to dampen the vibrations transmitted from one of said parts to the other.

More specifically, the invention relates, according to a first aspect, to a hydroelastic joint having first and second axial ends spaced apart from one another along a longitudinal axis and including, at an increasing radial distance from this axis, at least one internal frame, an intermediate frame with a window or “cage”, and an external sleeve, which joint also includes an elastomer packing molded with at least one molding insert chosen from the assembly including the internal frame, the cage and the external sleeve, in which said packing at least partially forms a wall for at least two hydraulic fluid chambers communicating with one another through at least one channel.

A hydroelastic joint of this type is described in particular in patent document FR 2 830 911, with other examples of joints being provided in patent documents U.S. Pat. No. 4,971,456, FR 2 853 379, and EP 0 499 996.

Traditionally, the chambers of these joints are defined by radial recessed spaces, hollowed between the arms of the cage.

In conjunction with the above, the production of these joints requires the use of loose-detail molds, which have the disadvantage of being expensive, bulky and relatively difficult to use.

The invention is based on a questioning of the presumably obligatory nature of the standard structure of hydroelastic joints, and the disadvantages associated with this structure.

To overcome these disadvantages, the joint of the invention, which is otherwise consistent with the general definition provided in the preamble above, is essentially characterized in that it also includes sealing means, in that the assembly formed by the packing and each insert has at least an essentially axial molding reserve, and in that each chamber and each channel are defined inside the molding reserve and are sealed or delimited, at least in an axial direction, by the sealing means.

According to the preferred embodiment of the invention, the molding reserve and the sealing means together delimit, in angular areas offset from one another about the longitudinal axis in an alternating manner, at least two free spaces with larger volumes and two free spaces with smaller volumes, in which each larger-volume free space houses at least one of said chambers, and at least one smaller-volume free space houses said channel.

To do this, it is possible for the molding reserve to have, at the first axial end of the joint, an opening that is axially sealed by the sealing means, which opening is, for example, annular.

However, the second axial end that each chamber has at the second axial end of the joint can be axially sealed by the packing.

In at least one possible embodiment of the invention, the sealing means include a plastic deformation of the external sleeve, resulting from a radial swaging.

In other possible embodiments of the invention, the sealing means include, for example, a attached part, axially sunken into the molding reserve, which attached part includes at least one base axially sealing the opening of the molding reserve.

It is then possible to envisage providing the base of the attached part with a peripheral groove into which the first axial end of the cage is nested, and for this base to form a mechanical bridge between the first axial end of the cage and a first end of the internal frame and/or the external sleeve.

The base of the attached part can also have an internal edge radially closer to the axis than the first axial end of the cage and adapted to form a stop to limit the radial displacement of the internal frame with respect to the sleeve.

It is also possible for the cage and the sleeve or the cage and the internal frame to be connected to one another by their second respective axial ends and thus to form a single part.

In addition, the packing can have at least one maximum pressure valve enabling two chambers to communicate with one another directly if there is excess pressure, with the attached part having an axial rib suitable for holding an edge of a lip of said valve.

In an advantageous embodiment of the invention, at least one of the elements constituted by the internal frame, the cage, the sleeve and the attached part is made of a polymer material, preferably by molding.

The invention also relates to a process for producing a hydroelastic joint having first and second axial ends spaced apart from one another along a longitudinal axis, and including, at an increasing radial distance from this axis, at least one internal frame, an intermediate frame with a window or “cage’, and an external sleeve, which joint also includes an elastomer packing molded with at least one molding insert chosen from the assembly including the internal frame, the cage and the external sleeve, in which said packing at least partially forms a wall for at least two hydraulic fluid chambers, which process is characterized in that it includes an operation consisting of molding, in one operation, the packing on the cage and on the external sleeve and/or on the internal frame.

In this case, the mold removal operation can be performed by relative distancing, according to the longitudinal axis, of the mold and the assembly formed by the packing and each insert, optionally accompanied by a rotation about said axis and/or an elastic deformation of the packing.

Other features and advantages of the invention will become clear from the following description, provided for indicative and non-limiting purposes, in reference to the appended drawings, in which:

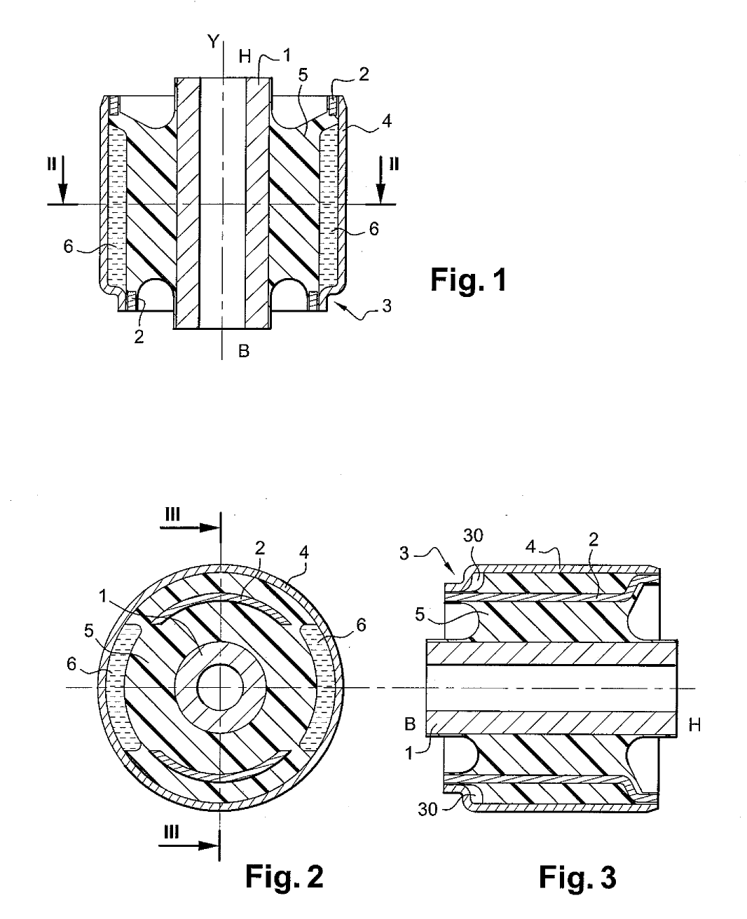

FIG. 1 is an axial cross-section view of a joint according to a first possible embodiment of the invention;

FIG. 2 is a transverse cross-section view of the joint shown in FIG. 1, which cross-section is shown according to the plane indicated by the arrows II-II of FIG. 1;

FIG. 3 is an axial cross-section view of the joint shown in FIG. 1, which cross-section is shown according to the plane indicated by the arrows III-III of FIG. 2;

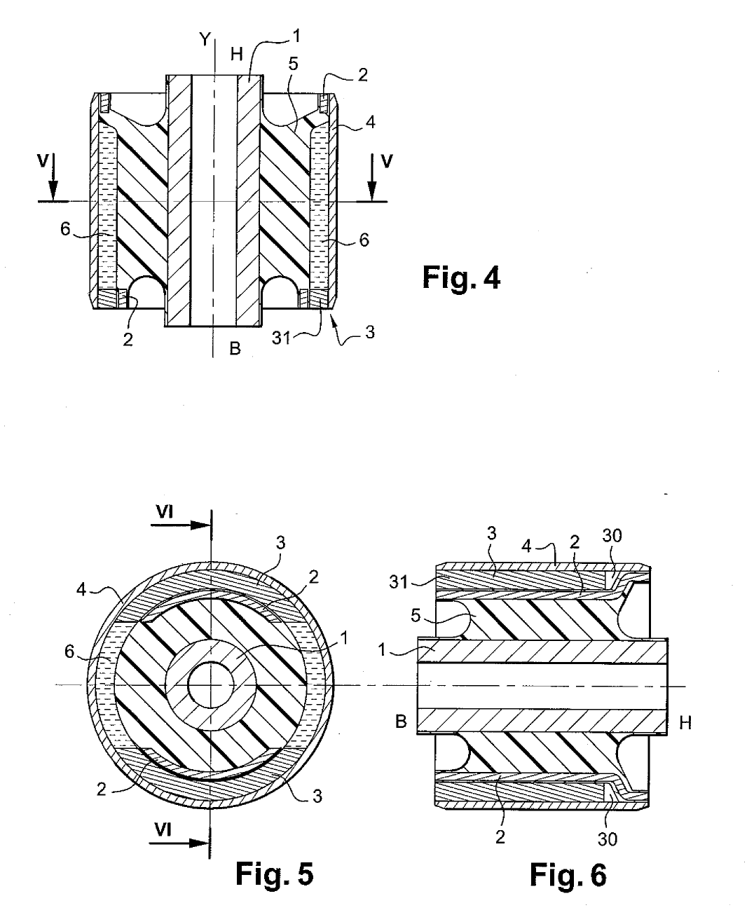

FIG. 4 is an axial cross-section view according to a second possible embodiment of the invention;

FIG. 5 is a transverse cross-section view of the joint shown in FIG. 4, which cross-section is shown according to the plane indicated by the arrows V-V of FIG. 4;

FIG. 6 is an axial cross-section view of the joint shown in FIG. 4, which cross-section is shown according to the plane indicated by the arrows VI-VI of FIG. 5;

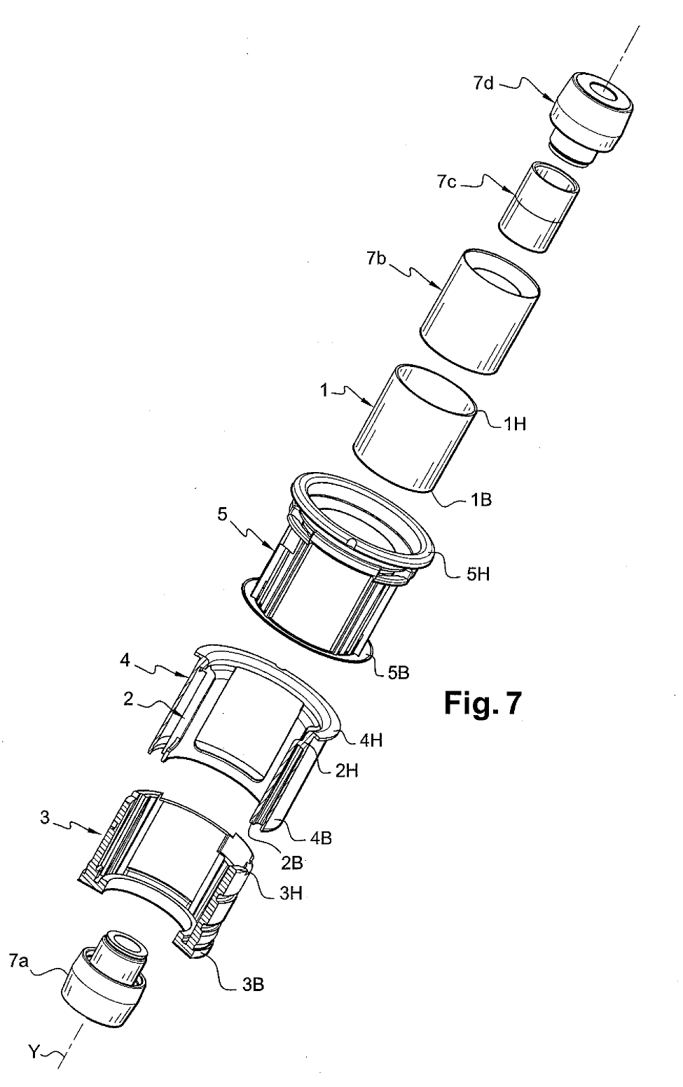

FIG. 7 is an exploded perspective and partial cross-section view of a joint according to a third possible embodiment of the invention;

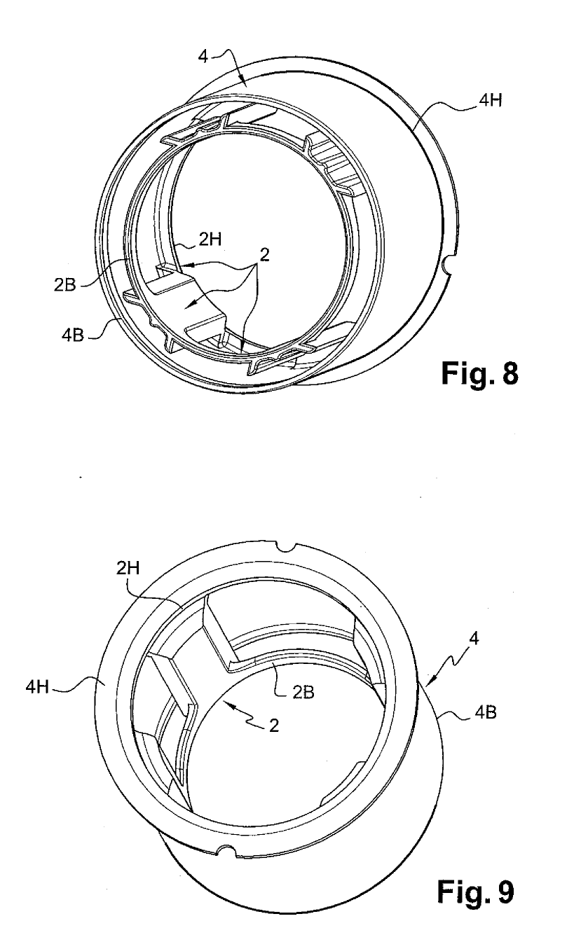

FIG. 8 is a perspective view of a single part forming the cage and the external sleeve of the joint shown in FIG. 7, seen from the side of its first axial end;

FIG. 9 is a perspective view of a single part forming the cage and the external sleeve of the joint shown in FIG. 7, seen from the side of its second axial end;

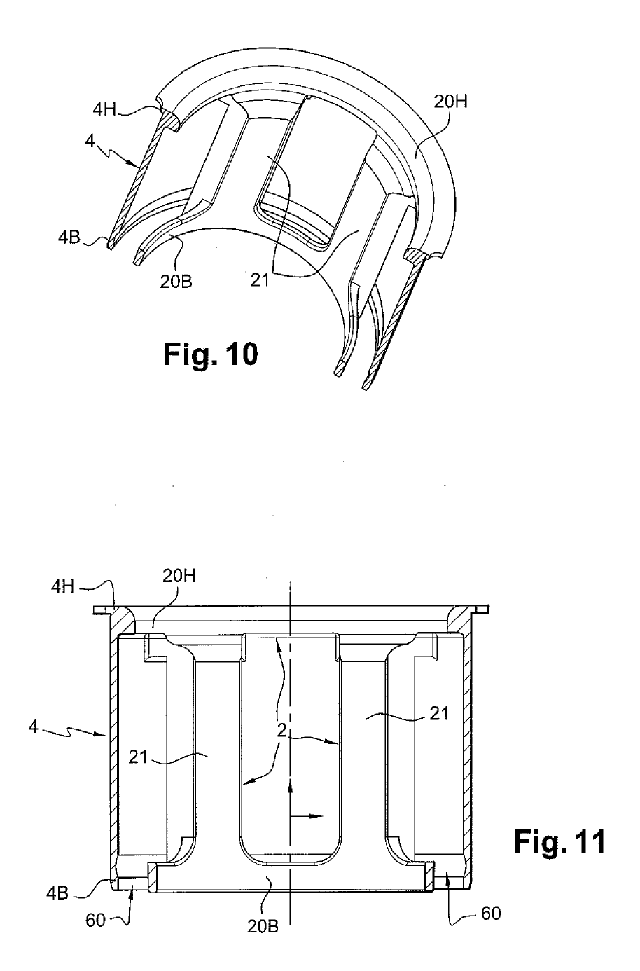

FIG. 10 is a perspective view of the part shown in FIG. 9, cat along an axial plane;

FIG. 11 is a cross-section view according to an axial plane of the part shown in FIG. 9;

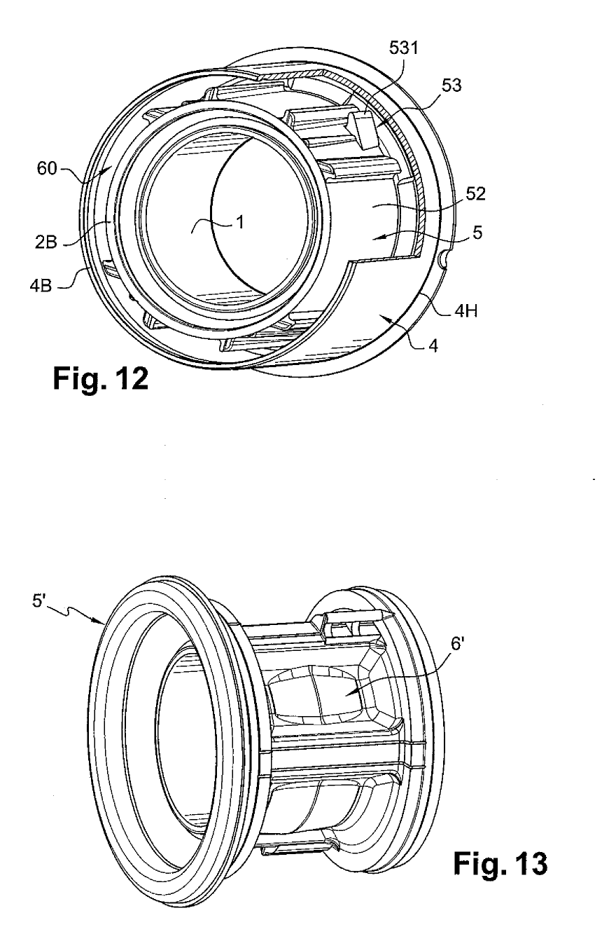

FIG. 12 is a partially cutaway perspective view of the packing and the assembly of inserts that it has in the third embodiment of the invention;

FIG. 13 is a perspective view of the packing of a joint known from the prior art,

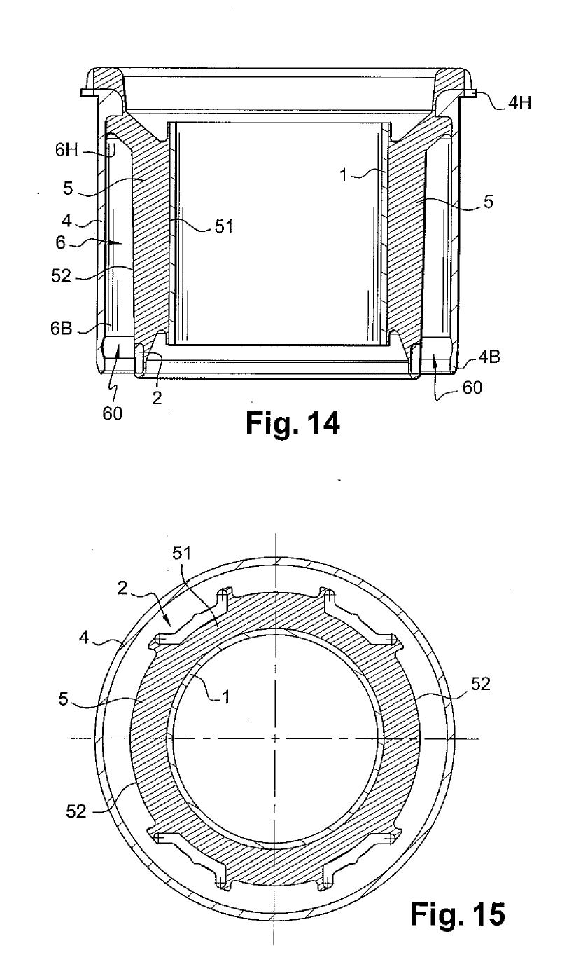

FIG. 14 is a cross-section view according to an axial plane of the packing and the assembly of inserts that it has in the third embodiment of the invention;

FIG. 15 is a transverse cross-section view of the packing and the assembly of inserts that it has in the third embodiment of the invention;

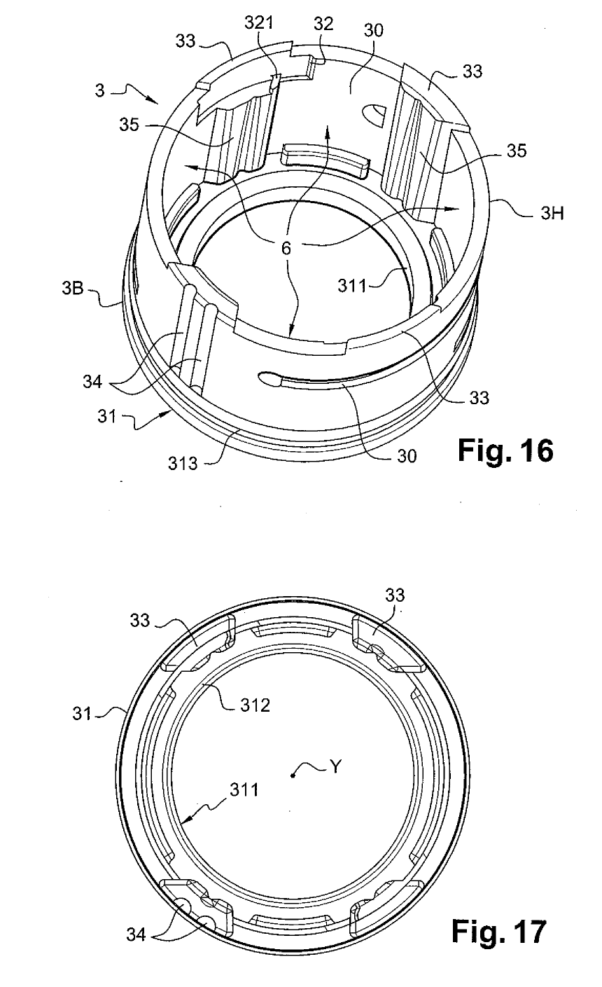

FIG. 16 is a perspective view of the attached part forming a dispenser;

FIG. 17 is a top view of the dispenser shown in FIG. 16;

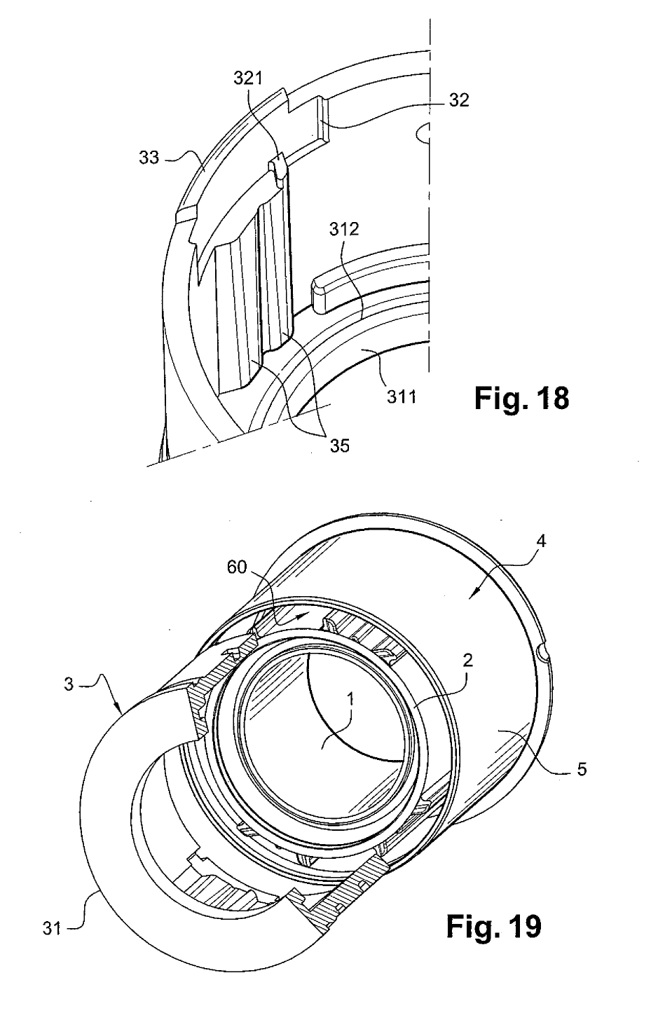

FIG. 18 is an enlarged view of a detail of FIG. 16;

FIG. 19 is a partially exploded and cutaway perspective view of a joint according to the invention;

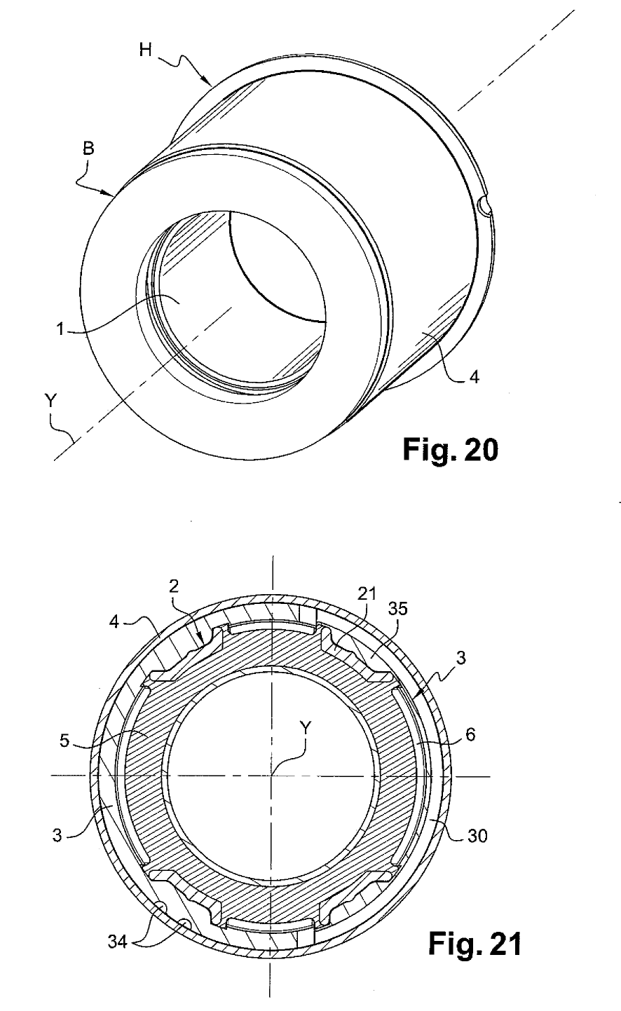

FIG. 20 is a perspective view of a joint according to the invention;

FIG. 21 is a transverse cross-section view of the joint shown in FIG. 20;

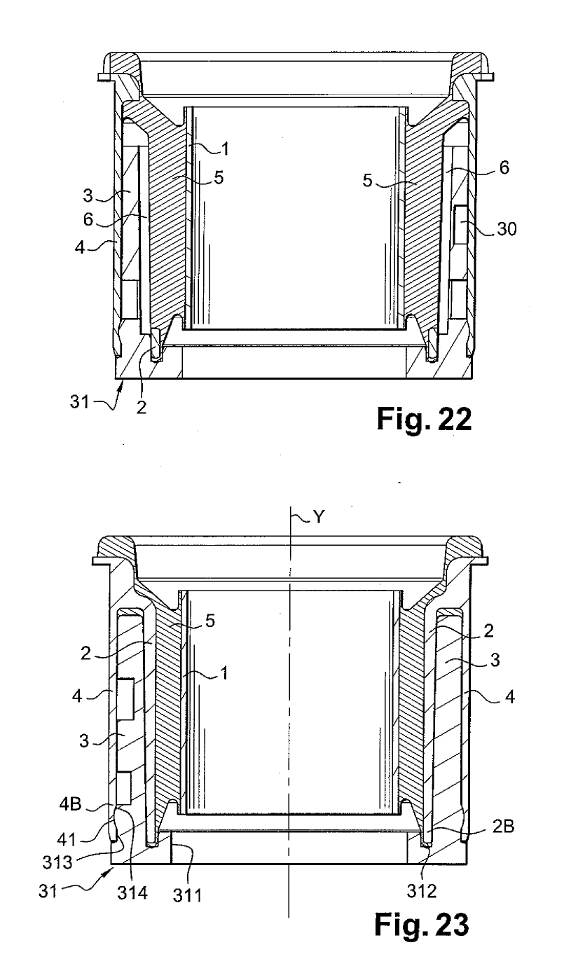

FIG. 22 is a cross-section view of the joint shown in FIG. 20, with the cross-section shown according to a first axial plane;

FIG. 23 is another cross-section view of the joint shown in FIG. 22, with the cross-section shown according to a second axial plane different from the first;

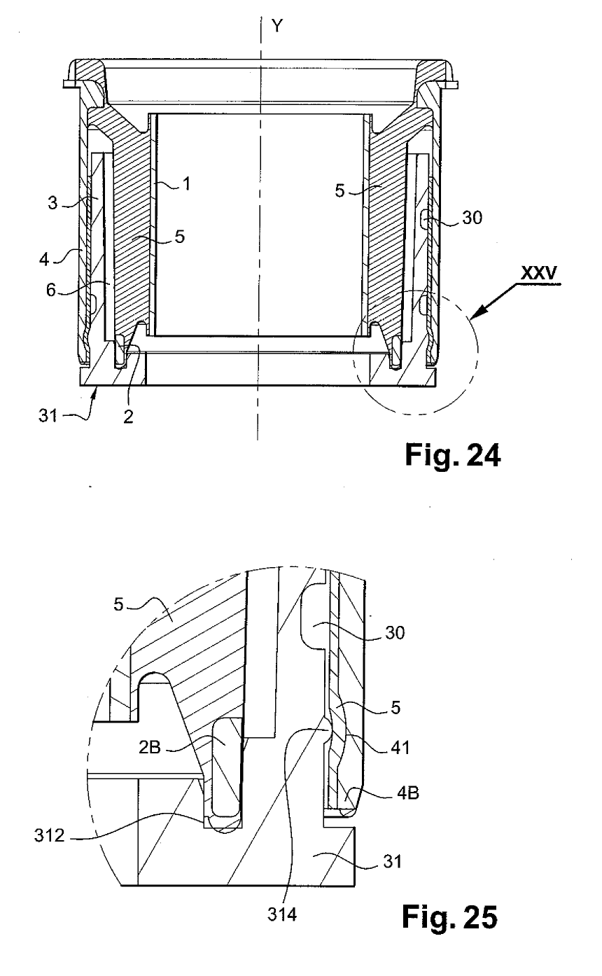

FIG. 24 is a cross-section view of an alternative of the joint shown in FIGS. 22 and 23;

FIG. 25 is an enlarged view of the detail indicated by reference XXV in FIG. 24;

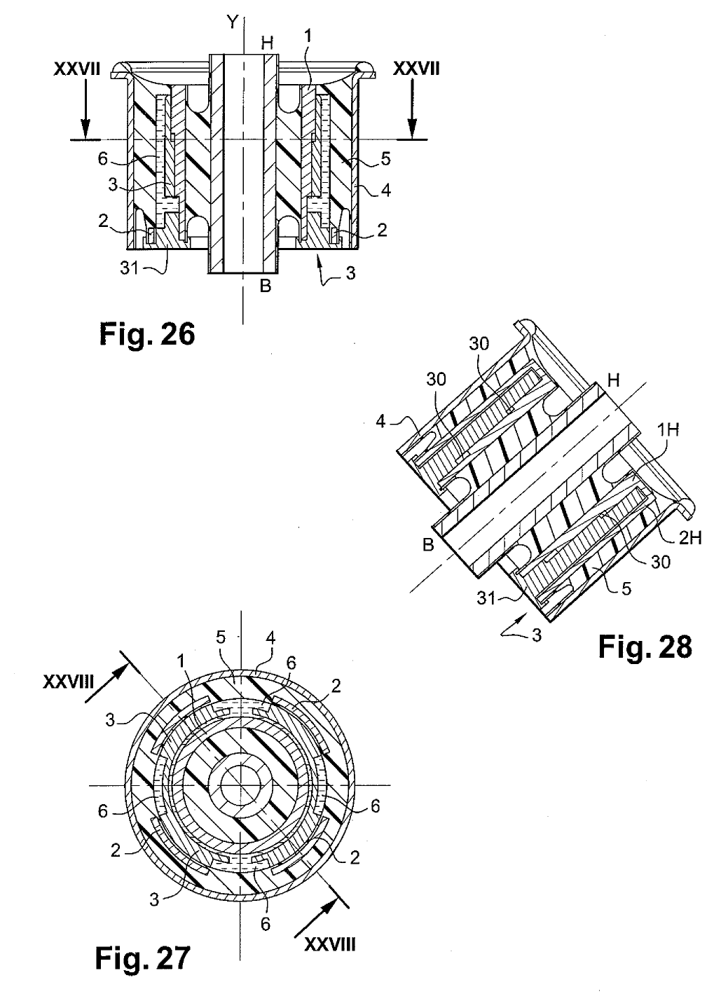

FIG. 26 is an axial cross-section view of a joint according to a fourth possible embodiment of the invention;

FIG. 27 is a transverse cross-section view of the joint shown in FIG. 26; this cross-section is shown according to the plane indicated by the arrows XXVII-XXVII of FIG. 26; and

FIG. 28 is an axial cross-section view of the joint shown in FIG. 26; this cross-section is shown according to the plane indicated by the arrows XXVIII-XXVIII of FIG. 27.

As mentioned above, the invention relates to a generally hollow cylindrical hydroelastic joint (FIG. 20) having axial ends B and H spaced apart from one another along a longitudinal axis Y and, by convention, respectively designated as lower and upper.

As shown in particular in FIGS. 1, 4, 7 and 26, this joint includes at least, at an increasing radial distance from said axis Y, an internal frame 1, an intermediate frame 2 with a window, and an external sleeve 4.

The frame with window 2, more commonly called “cage”, can essentially be formed by two rings 20B and 20H connected by axial arms 21 (FIG. 11).

This joint also includes a packing 5 made of an elastomer material, as well as, optionally, additional parts 7a to 7d (FIG. 7) that do not specifically belong to the invention.

The packing 5 is obtained by molding in a mold where one or more elements chosen from the assembly including the internal frame 1, the cage 2 and the external sleeve 4 are also introduced as inserts.

This packing 5 at least partially forms a wall for a plurality of hydraulic fluid chambers 6, which communicate with one another at least in pairs through a channel or a plurality of channels 30.

With this arrangement, the relative radial movements between the internal frame 1 and the external sleeve 4 cause, in a manner known per se, variations in volume of the different chambers, and therefore a circulation of the hydraulic fluid between the different chambers 6 through the channels 30 of the dispenser.

The relative radial movements between the internal frame 1 and the external sleeve 4 can thus be attenuated and frequency filtered owing to the resistance due to the inertial effect of the channels 30 on the circulation of fluid between the different chambers 6.

The packing 5, which has an internal part 51 and a peripheral part 52, can in particular connect the cage 2 to the internal frame 1 (FIGS. 1, 4, 15) or connect the cage 2 to the external sleeve (FIG. 26).

In the first case, the peripheral part 52 of the packing 5 typically forms an internal wall for the chambers 6, while in the second case, the internal part 51 of the packing 5 forms a radially external wall for the chambers 6.

In addition to the elements mentioned above, the joint includes sealing means 3 that are capable of lining various forms.

Moreover, the assembly formed by the packing 5 and each insert has at least an essentially axial molding reserve.

The term “molding reserve” refers to the volume left free of any material in a molding operation, owing to the presence, in the mold, of a core that occupies this volume.

By convention, a molding reserve that is “at least essentially axial” in the sense of this description is a molding reserve that is strictly axial or, if not, that has only helical radial cavities or cavities of small enough sizes for the mold removal operation to be performed by relative distancing, according to the longitudinal axis Y, of the mold and the assembly formed by the packing 5 and each insert, optionally accompanied by a rotation about said axis Y and/or an elastic deformation of the packing 5.

Each chamber 6 and each channel 30 can thus be defined inside the molding reserve and are sealed or delimited, at least in an axial direction, by the sealing means 3.

Each of elements 1 to 5 of the joint has a lower axial end 1B to 5B, or an upper axial end 1H to 5H.

As shown in pairs, FIGS. 1 and 3, 4 and 6, 22 and 23, and 26 and 28, the molding reserve and the sealing means 3 together delimit free spaces of different volumes in respective angular areas offset by one another about the longitudinal axis Y.

The free spaces of relatively large volume, each of which houses a chamber 60, alternate with the free spaces of relatively small volume, of which at least one houses the channel 30.

More specifically, in the embodiments including two chambers (FIGS. 1 to 6), the molding reserve and the sealing means 3 together delimit two free spaces of relatively large volume alternating with two free spaces of relatively small volume, and in the embodiments including four chambers (FIGS. 7 to 12 and 14 to 28), the molding reserve and the sealing means 3 together delimit four free spaces of relatively large volume alternating with four free spaces of relatively small volume.

In every case, the molding reserve has, at the lower axial end B of the joint, at least one opening 60 (see, for example, FIG. 12), which enables the removal of the packing 5 and the set of inserts thereof along the axis Y, and which is axially sealed by the sealing means 3.

This structure is thus fundamentally distinguished from the structure of a known joint as shown in FIG. 13, in which the packing 5′ defines chambers 6′, each of which is bordered both axially and radially.

As shown in particular in FIGS. 1, 4, 14 and 26, the opening 60 left by the molding reserve before the placement of sealing means 3 can advantageously be annular.

Moreover, as shown in these same figures, the upper axial end 6H of each chamber 6 is preferably axially sealed by the packing 5.

In the embodiment shown in FIGS. 1 to 3, the sealing means 3 are in fact constituted by a plastic deformation of the external sleeve, resulting from a radial recess.

In addition, the larger-volume free spaces, which form the chambers 6 (FIG. 1), are obtained by ensuring that the packing 5, in the corresponding angular areas, extends axially only over a small distance and in proximity only to the upper end H of the joint, whereas the smaller-volume free spaces, which form the channels 30 (FIG. 3), are obtained by ensuring that the packing 5, in the corresponding angular areas, extends axially over a larger distance, from the upper end H to near the lower end B of the joint.

The other figures, with the exception of FIG. 13, which does not concern the invention, show embodiments in which the sealing means are constituted by an attached part 3.

This attached part is axially sunken into the molding reserve, and includes a base 31 axially sealing the opening 60 of this molding reserve.

In the embodiment shown in FIGS. 4 to 6, the larger-volume free spaces which form the chambers 6 (FIG. 4), are obtained by ensuring that the attached part 3, in the corresponding angular areas, extends axially only over a small distance and in proximity only to the lower end B of the joint, whereas the smaller-volume free spaces, which form the channels 30 (FIG. 6), are obtained by ensuring that the attached part 3, in the corresponding angular areas, extends axially over a larger distance, from the lower end B to near the upper end H of the joint.

FIGS. 7 to 12 and 14 to 25 show a third embodiment for a joint according to the invention, equipped with more elaborate features described in detail below.

In this embodiment, and as best shown in FIGS. 14, 15, 16, 22 and 23, the fragmentation of the total volume, initially occupied by the molding reserve, into smaller volumes constituting the chambers 6 and the channels 30 is provided almost exclusively by the attached part 3, which thus acts as a dispenser.

In addition, to avoid damage to this joint in the event of a violent shock causing excess pressure of the fluid in one of the chambers 6, the molded packing 5 has, in a manner known per se, one or more maximum pressure valves 53 enabling two different chambers 6 to communicate with one another directly.

As shown in particular in FIGS. 8 to 11, the cage 2 and the sleeve 4 are preferably connected to one another by their respective upper axial ends 2H and 4H, so that they form only a single part and can be produced together, in particular by molding.

More generally, the cage 2, the sleeve 4, the dispenser 3 and/or the annular base 31 can advantageously be made of aluminum or a polymer material.

These parts can therefore be obtained by molding and have relatively elaborate shapes enabling them to easily perform multiple functions.

The production of the joint can be further simplified by introducing the external sleeve 4, as an additional insert, into the mold used for the molding of the elastomer packing 5.

The base 31 of the attached part 3 has the shape of an annular collar forming an integral part of this part 3, with the latter acting as a dispenser.

This part or this dispenser 3, more specifically shown in FIGS. 16 to 18, performs multiple functions and thus has a relatively elaborate structure.

First, the collar 31 of this dispenser 3 has an internal edge 311 arranged at closer radial proximity to the axis Y than the lower axial end 2B of the cage 2, which internal edge is designed to limit the radial displacement of the part 7a associated with the internal frame 1, and therefore to form a stop limiting the radial displacement of the internal frame 1 with respect to the sleeve 4.

At its upper axial end 3H, the dispenser 3 has contacts 33 intended to be applied on the elastomer packing 5 in order to ensure the tightness between the chambers 6 of each pair of neighboring chambers.

The collar 31 of the dispenser 3 also has an internal peripheral groove 312 (FIG. 23) into which the lower axial end 2B of the cage 2 is nested, which is thus rigidly connected, by the base of the attached annular part 3 that forms the collar 31, at the lower axial end 4B of the sleeve 4.

The dispenser 3 has, on its internal face, bosses 35 parallel to axis Y (to the nearest clearance angle) and intended to be applied on the arms of the cage 2 (FIG. 21) in order to ensure the angular locking of the dispenser 3 with respect to the cage 2 about said axis Y and the radial cohesion of said dispenser and the cage with respect to the radial forces exerted between the internal frame 1 and the sleeve 4.

To prevent a maximum pressure valve 53 of the molded packing 5 from accidentally adhering to the internal face of the sleeve 4 during the molding of said packing, and to ensure the geometry of said valve, each valve 53 is sized so as to be separated by a non-zero distance from the internal face of the sleeve 4.

It is then possible for each valve 53 to cooperate with the base of a counter-bore 32 hollowed in the internal face of the dispenser 3 between two neighboring chambers, on the generatrix of a boss 35.

Alternatively, the dispenser can have a window in place of the counter-bore, with each valve 53 then cooperating directly with the internal face of the sleeve 4, once said valve has been approached by said internal face by the radial constraint applied to the joint before it is used.

In both cases, the dispenser 3 preferably has an axial rib 321 suitable for holding the upper edge 531 of the lip of said valve 53.

The collar 31 (FIG. 23) also comprises an external peripheral groove 313, in which the lower end 4B of the sleeve 4 locks, itself hollowed by an internal peripheral groove 41, applied on a protuberance 314 of said collar 31.

This arrangement leads to the development of an axial bearing force of the collar 31 on the respective ends 2B and 4B of the cage 2 and the sleeve 4, which bearing force can be used to ensure the axial compression of O-rings arranged between the end 2B of the cage 2 and the collar 31, and between the end 4B of the sleeve and said same collar 31.

The O-ring formed between the end 2B of the cage 2 and the collar 31, barely visible in FIGS. 22 and 23, is arranged at the base of the internal peripheral groove 312 of the collar 31 and clearly visible in FIG. 25, which shows an alternative embodiment of the tightness between the end 4B of the sleeve 4 and the collar 31.

According to this alternative, a fine layer of elastomer packing 5 is deposited on the internal lateral face of the sleeve 4 and in particular at the base of the internal peripheral groove 41 of this sleeve, with the tightness being achieved by radial compression of said packing layer 5 between the protuberance 314, in this case rounded, of the collar 31 and the base of the groove 41 of the sleeve 4.

Finally, the external face of the dispenser 3 is hollowed by discharge channels 34, for example, formed on the back of the bosses 35 and in the same direction, and enabling the hydraulic fluid present in overabundance in the chambers 6 to be discharged from the latter when the dispenser 3 is inserted into the annular space 60, while optionally applying a slight excess pressure on the fluid remaining trapped.

The process for producing the hydroelastic joint corresponding in particular to this embodiment is preferably implemented by producing the internal frame 1, for example in the form of a metal tube section, by producing, in a single part (FIGS. 8 to 11), the cage 2 and the external sleeve 4 by injecting aluminum or a mechanically resistant polymer into a first mold, by producing the dispenser 3 (FIGS. 16 to 18) by injecting aluminum or a mechanically resistant polymer into a second mold, by forming, by molding in a third mold, the packing 5 on the inserts constituted by the internal frame 1, the cage 2 and the sleeve 4 (FIGS. 14 and 15), by removing this part by relative distancing, according to the longitudinal axis Y, the third mold from the packing 5 with its inserts, by immersing the part molded with the packing into the hydraulic fluid, and by inserting the dispenser 3 and its sealing collar 31 into the annular opening 60 of the part molded with the packing, still submerged in the hydraulic fluid.

FIGS. 26 to 28 show a fourth embodiment of a joint according to the invention, in which the attached part 3 also performs the role of dispenser, at least in combination with the internal frame 1.

In this embodiment, the internal frame 1 and the cage 2 are connected to one another by their respective upper axial ends 1H and 2H (FIG. 2B), so that they form only a single part and can be produced together, in particular by molding.

The attached part 3, which forms a dispenser, is axially inserted into the molding reserve between the internal frame 1 and the cage 2, with each chamber 6 thus having a radially internal wall partially formed by said part 3 and a radially external wall formed by the packing 5.

The molding reserve is thus shared by four chambers 6, which communicate with one another, at least in pairs, by means of channels 30 defined between shoulders of the internal frame 1 and shoulders of the attached part 3.

1. A hydroelastic joint having first and second axial ends spaced apart from one another along a longitudinal axis and including, at an increasing radial distance from this axis, at least one internal frame, an intermediate frame with a window or “cage”, and an external sleeve, which joint also includes an elastomer packing molded with at least one molding insert chosen from the assembly including the internal frame, the cage and the external sleeve, in which said packing at least partially forms a wall for at least two hydraulic fluid chambers communicating with one another through at least one channel, and sealing means, wherein the assembly formed by the packing and each insert has at least an essentially axial molding reserve, and wherein each chamber and each channel are defined inside the molding reserve and are sealed or delimited, at least in an axial direction, by the sealing means.

2. The hydroelastic joint according to claim 1, wherein the molding reserve and the sealing means together delimit, in angular areas offset from one another about the longitudinal axis and in an alternating manner, at least two free spaces with larger volumes and two free spaces with smaller volumes, in which each larger-volume free space houses at least one of said chambers, and at least one smaller-volume free space houses said channel.

3. The hydroelastic joint according to claim 1, wherein the molding reserve has, at the first axial end of the joint, an opening that is axially sealed by the sealing means.

4. The hydroelastic joint according to claim 3, wherein said opening is annular.

5. The hydroelastic joint according to claim 1, wherein each chamber has, at the second axial end of the joint, a second axial end axially sealed by the packing.

6. The hydroelastic joint according claim 1, wherein the sealing means include a plastic deformation of the external sleeve, resulting from a radial swaging.

7. The hydroelastic joint according to claim 3, wherein the sealing means include an attached part, axially sunken into the molding reserve, which attached part includes at least one base axially sealing the opening of the molding reserve.

8. The hydroelastic joint according to claim 7, wherein the base of the attached part has a peripheral groove into which the first axial end of the cage is nested, and wherein this base forms a mechanical bridge between the first axial end of the cage and a first end of the internal frame and/or the external sleeve.

9. The hydroelastic joint according to claim 7, wherein the base of the attached part has an internal edge radially closer to the axis than the first axial end of the cage and adapted to form a stop to limit the radial displacement of the internal frame with respect to the sleeve.

10. The hydroelastic joint according to claim 1, wherein the cage and the sleeve or the cage and the internal frame are connected to one another by their second respective axial ends and thus form a single part.

11. The hydroelastic joint according to claim 1, wherein the packing has at least one maximum pressure valve enabling two chambers to communicate with one another directly if there is excess pressure, and in that the attached part has an axial rib suitable for holding an edge of a lip of said valve.

12. The hydroelastic joint according to claim 1, wherein at least one of the elements constituted by the internal frame, the cage, the sleeve and the attached part is made of a polymer material, preferably by molding.

13. A process for producing a hydroelastic joint having first and second axial ends spaced apart from one another along a longitudinal axis, and including, at an increasing radial distance from this axis, at least one internal frame, an intermediate frame with a window or “cage”, and an external sleeve, which joint also includes an elastomer packing molded with at least one molding insert chosen from the assembly including the internal frame, the cage and the external sleeve, in which said packing at least partially forms a wall for at least two hydraulic fluid chambers, wherein the process comprises the steps of molding, in one operation, the packing on the cage and on the external sleeve and/or on the internal frame.

14. The production process according to claim 13, wherein mold removal is performed by relative distancing, according to the longitudinal axis, of the mold and the assembly formed by the packing and each insert, optionally accompanied by a rotation about said axis and/or an elastic deformation of the packing.
